(19) United States
(12) Patent Application Publication
(10) Pub. No.: US 2011/0082034 A1
(43) Pub. Date: Apr. 7, 2011

(54) NANOTUBE-NANOHORN COMPLEX AND METHOD OF MANUFACTURING THE SAME

(76) Inventors: Ryota Yuge, Tokyo (JP); Sadanori Hattori, Tokyo (JP); Masako Yudasaka, Tokyo (JP); Sumio Iijima, Tokyo (JP)

(21) Appl. No.: 12/997,325

(22) PCT Filed: Jun. 18, 2009
(86) PCT No.: PCT/JP2009/061555

§ 371 Date: Dec. 10, 2010

(30) Foreign Application Priority Data
Jun. 30, 2008 (JP) 2008-169942

(51) Int. Cl. B01J 21/18; C09K 11/65; H01M 4/90; B82Y 30/00; B82Y 40/00

(52) U.S. Cl. 502/439; 252/301.4 R; 252/182.1; 977/742; 977/734

(57) ABSTRACT

An object of the present invention is to provide a nanotube-nanohorn complex having an aspect ratio higher than that of a conventional one, also having high dispersibility, and being capable of growing carbon nanotubes with controlled diameter. A nanotube-nanohorn complex according to the present invention comprises carbon nanohorn and catalyst fine particles supported within the carbon nanohorn. The carbon nanohorn comprise an aperture formed therein. Each of the catalyst fine particles is fitted and fixed in the aperture in a state in which part of the catalyst fine particle is exposed to the exterior of the carbon nanohorn. Carbon nanotubes are grown from the catalyst fine particles.

### TECHNICAL FIELD

The present invention relates to a nanotube-nanohorn complex and a method of manufacturing the same.

### BACKGROUND ART

Carbon nanotubes have such characteristics that they have a high aspect ratio, are chemically stable, and are mechanically strong. Therefore, carbon nanotubes have greatly been expected as field emission light-emitting, devices. Carbon nanotubes have diligently been studied, for example, as disclosed in Japanese laid-open patent publications Nos. 2001-143645 (Patent Document 1) and 2000-86219 (Patent Document 2).

In most cases where carbon nanotubes are used as field emission elements, for example, as disclosed in Japanese laid-open patent publications No. 2007-103313 (Patent Document 3) and 2007-265749 (Patent Document 4), it has been customary to mix a binder or the like so as to produce paste for application onto an electrode by spraying, screen printing, or the like. However, the dispersibility of carbon nanotubes is so poor that homogeneous paste cannot be obtained. Accordingly, there has been a large problem in uniformity of the light emission.

In recent years, aggregates of carbon nanohorn, which have a horn structure with a sheath structure like a carbon nanotube and a closed end, have been found as disclosed in Japanese laid-open patent publication No. 2002-159851 (Patent Document 5). The unique structure of a carbon nanohorn has industrially attracted attention as a fuel cell or a catalyst carrier for steam reforming to produce hydrogen from hydrocarbon such as methane, as disclosed in Japanese laid-open patent publication No. 2007-7599 (Patent Document 6). Recently, carbon nanohorn have also greatly been expected as field emission elements as disclosed in Japanese laid-open patent publications Nos. 2003-77385 (Patent Document 7) and 2009-076314 (Patent Document 8).

It has been known that carbon nanohorn are nanocarbon having high conductivity because they have a tubular structure. Carbon nanohorn are spherical aggregates having a diameter of 1 nm to 5 nm in which the length of a sheath comprising a horn structure is in a range of 30 nm to 200 nm. Although carbon nanohorn have higher dispersibility than carbon nanotubes, the aspect ratio is so low that carbon nanohorn are unsuitable to field emission elements and the like.

International Patent Publication No. 2007/088829 (Patent Document 9) has reported that a carbon nanotube can grow from a catalyst encapsulated in a carbon nanohorn or supported in an outer wall of a carbon nanohorn by a chemical deposition method. However, the size of the catalyst cannot uniformly be dispersed at a high level. Furthermore, it is difficult to grow carbon nanotubes controlled in diameter with high dispersibility.

### DISCLOSURE OF INVENTION

The invention of the present application has been made under the above circumstances. In order to solve conventional problems, an object of the present invention is to provide a nanotube-nanohorn complex having a high aspect ratio, also having high dispersibility, and being capable of growing carbon nanotubes with controlled diameter because the size of catalysts is determined by the diameter of sheaths of nanohorn.

Specifically, a first invention of this application is a nanotube-nanohorn complex characterized by comprising carbon nanohorn and catalyst fine particles supported within the carbon nanohorn, wherein each of the carbon nanohorn comprises an aperture formed therein, each of the catalyst fine particles is fitted and fixed in the aperture in a state in which part of the catalyst fine particle is exposed to an exterior of the carbon nanohorn, and carbon nanotubes are grown from the catalyst fine particles.

Furthermore, a second invention of this application is a nanotube-nanohorn complex characterized by comprising carbon nanohorn and catalyst fine particles supported within the carbon nanohorn, wherein each of catalyst fine particles is supported at a tip of the carbon nanohorn in a state in which part of the catalyst fine particle is exposed to an exterior of the carbon nanohorn, and carbon nanotubes are grown from the catalyst fine particles.

Moreover, a third invention of this application is a method of manufacturing a nanotube-nanohorn complex, characterized by comprising a process (a) of forming an aperture in a carbon nanohorn, a process (b) of introducing a catalyst fine particle or a precursor thereof into the carbon nanohorn through the aperture, a process (c) of removing the carbon nanohorn around a portion with which the introduced catalyst fine particle or precursor is brought into contact so as to expose part of the catalyst fine particle or the precursor thereof to an exterior of the carbon nanohorn, and a process (d) of growing a carbon nanotube from the catalyst fine particle or the precursor thereof.

Furthermore, a fourth invention of this application is a field emission element characterized by comprising the nanotube-nanohorn complex of the first invention or the second invention.

Moreover, a fifth invention of this application is a fuel cell characterized by comprising the nanotube-nanohorn complex of the first invention or the second invention.

Furthermore, a sixth invention of this application is a catalyst carrier for steam reforming, characterized by comprising the nanotube-nanohorn complex of the first invention or the second invention.

### EFFECT(S) OF THE INVENTION

According to the invention of the present application, there can be provided a nanotube-nanohorn complex having an aspect ratio higher than that of a conventional one, also having high dispersibility, and being capable of growing carbon nanotubes with controlled diameter. Use of such a nanotube-nanohorn complex to produce a field emission element expects uniform light emission from the carbon nanotubes controlled in diameter.

Furthermore, since the nanotube-nanohorn complex is a complex of nanotubes and nanohorn, the nanotubes are moderately dispersed on a surface of an electrode. Therefore, the electric field is likely to concentrate. Accordingly, the nanotube-nanohorn complex is optimal for a field emission device with high luminance.

### BRIEF DESCRIPTION OF DRAWINGS

FIG. 1 is a diagram showing an overview of an example of a nanotube-nanohorn complex 1 according to the present invention.

FIG. 2A is a diagram showing a method of manufacturing the nanotube-nanohorn complex 1 according to the present invention.

FIG. 2B is a diagram showing a method of manufacturing the nanotube-nanohorn complex 1 according to the present invention.

FIG. 2C is a diagram showing a method of manufacturing the nanotube-nanohorn complex 1 according to the present invention.

FIG. 2D is a diagram showing a method of manufacturing the nanotube-nanohorn complex 1 according to the present invention.

FIG. 3 is a diagram simulating a TEM (transmission electron microscope) photograph of catalyst-carried carbon nanohorn produced according to the present invention, in which Fe catalysts were exposed at tips of the carbon nanohorn.

FIG. 4A is a diagram simulating an electron micrograph of nanotube-nanohorn complexes produced according to the present invention.

FIG. 4B is a diagram simulating an electron micrograph of nanotube-nanohorn complexes produced according to the present invention.

FIG. 4C is a diagram simulating an electron micrograph of nanotube-nanohorn complexes produced according to the present invention.

FIG. 5A is a Raman spectrum of nanotube-nanohorn complexes produced with a catalyst of Fe according to the present invention, in which the illustrated temperature represents the CVD temperature.

FIG. 5B is a Raman spectrum of nanotube-nanohorn complexes produced with a catalyst of Fe according to the present invention, in which the illustrated temperature represents the CVD temperature.

FIG. 6A is a Raman spectrum of nanotube-nanohorn complexes produced with catalysts of Fe, Co, CoMo, and Gd according to the present invention, in which the illustrated temperature represents the CVD temperature.

FIG. 6B is a Raman spectrum of nanotube-nanohorn complexes produced with catalysts of Fe, Co, CoMo, and Gd according to the present invention, in which the illustrated temperature represents the CVD temperature.

FIG. 7 is a graph showing the current density of electrons emitted from an electron emission source produced in the example so as to correspond to the intensity of the electric field, in which NTNH, MWNT, and CNH represent nanotube-nanohorn complexes, multilayered nanotubes, and carbon nanohorn, respectively.

### DESCRIPTION OF REFERENCE NUMERALS

1 nanotube-nanohorn complex

100 carbon nanohorn

101 aperture

102 encapsulated substance

### MODE(S) FOR CARRYING OUT THE INVENTION

The invention of the present application has features as described above. An embodiment of the present invention will be described below.

First, an overview of a structure of a nanotube-nanohorn complex 1 according to an embodiment will be described.

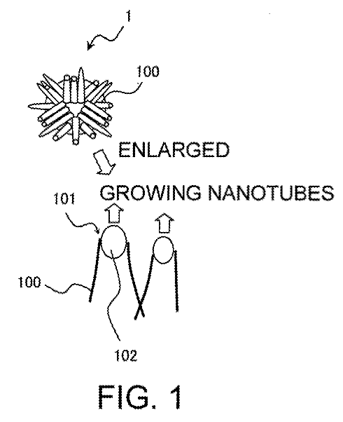

FIG. 1 is a schematic view showing an example of the nanotube-nanohorn complex 1 according to the present invention. As shown in FIG. 1, the nanotube-nanohorn complex 1 comprises a plurality of carbon nanohorn 100, which forms a spherical aggregate.

Apertures 101 are formed in tips or side surfaces of at least part of the carbon nanohorn 100. Catalyst fine particles 102, which will be described later, are fitted in the apertures 101 in a state such that part of the catalyst fine particles 102 is exposed to the exterior of the carbon nanohorn 100.

Alternatively, catalyst fine particles 102 are supported at tips of the carbon nanohorn 100 in a state such that part the catalyst fine particles 102 is exposed to the exterior of the carbon nanohorn 100.

Furthermore, carbon nanotubes, which are not shown in the drawings, have grown from the catalyst fine particles 102.

Next, an overview of a manufacturing process of the nanotube-nanohorn complex 1 according to the present invention will be described.

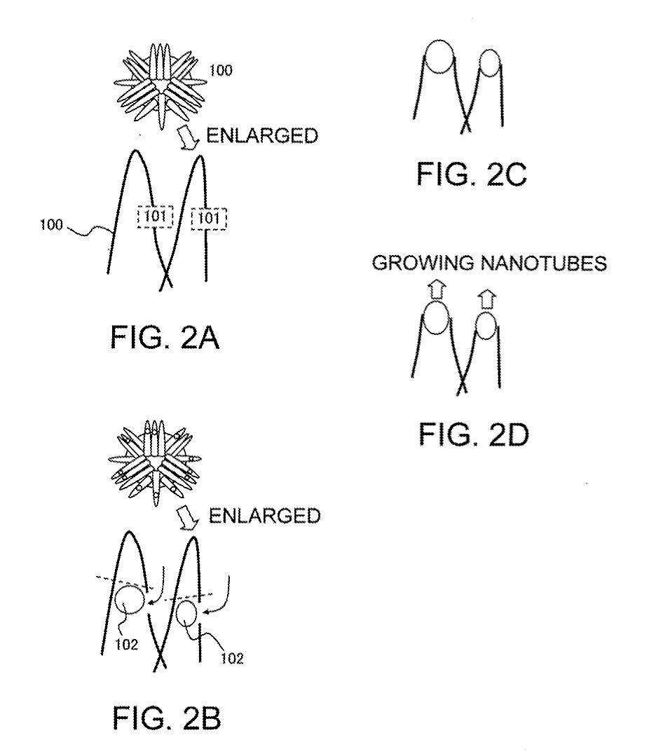

FIGS. 2A to 2D are diagrams schematically showing an overview of a manufacturing process of the nanotube-nanohorn complex 1 according to the present invention.

The manufacturing process according to the present invention is divided into four processes (1) to (4) and will be described below.

(1) Apertures are formed in carbon nanohorn.

In a method of manufacturing a nanotube-nanohorn complex 1 according to the present invention, as shown in FIG. 2A, an oxidation treatment is first performed to produce oxidized aperture carbon nanohorn. At that time, openings are formed at portions having a five-membered ring or a seven-membered ring on side surfaces or tips of carbon nanohorn 100. Apertures 101 are thus formed.

(2) Catalyst fine particles or precursors thereof are introduced into the carbon nanohorn through the apertures.

Next, as indicated by arrows in FIG. 2B, encapsulated substances 102 are taken as catalyst fine particles or precursors thereof into the carbon nanohorn 100 through the apertures 101. Specifically, the encapsulated substances 102 are sublimated, so that they are directly introduced into the carbon nanohorn 100. Alternatively, the encapsulated substances 102 are introduced into the carbon nanohorn 100 in a state in which they are dissolved in a solvent.

For example, the encapsulated substances 102 comprise a catalyst substance or a precursor thereof that uses a metal such as Fe, Ni, Co, Pt, Au, Cu, Mo, W, or Mg, or an alloy including Fe, Ni, Co, Pt, Au, Cu, Mo, W, or Mg.

(3) As shown in FIG. 2C, the carbon nanohorn 100 are subjected to a heat treatment in the air or the like around a temperature at which burning starts by a catalytic action at portions at which the introduced catalyst fine particles or precursors thereof are brought into contact with the carbon nanohorn 100. Thus, a carbon layer at the tips of the carbon nanohorn are removed by using a catalyst effect of the encapsulated substances, so that part of the catalyst fine particles or precursors thereof is exposed to the exterior of the carbon nanohorn while the catalysts are fixed by sheaths of the carbon nanohorn. At that time, portions around the encapsulated substances are burned. Thus, the carbon nanohorn 100 are burned to some extent. Therefore, the sheaths of the carbon nanohorn 100 are shortened, and the apertures 101 are enlarged.

(4) As shown in FIG. 2D, the samples produced as described above are placed in, for example, an electric furnace so as to grow carbon nanotubes from the catalysts at the tips of the carbon nanohorn 100 by a chemical vapor deposition (CVD) method.

Thus, a nanotube-nanohorn complex 1 is manufactured.

The carbon nanohorn 100 used as a starting substance are a spherical aggregate of nanohorn having a diameter of 1 nm to 5 nm with a tip of each horn being directed to outer sides of the aggregate. An aggregate having a diameter of 30 nm to 150 nm can be used. The size of the apertures can be controlled by various oxidation conditions in order to form fine holes (the apertures 101) in the carbon nanohorn 100. In a case of oxidation with a heat treatment under an oxygen atmosphere, the size of the holes in the carbon nanohorn 100 can be controlled by changing an oxidation temperature. Holes having a diameter of 0.3 nm to 1 nm can be formed at a temperature ranging from 350° C. to 550° C. Furthermore, holes can be formed by a treatment with an acid or the like as disclosed in Japanese patent application No. 2001-294499 (Japanese laid-open patent publication No. 2003-95624). For example, holes having a diameter of 1 nm can be formed at 1 10° C. in 15 minutes with a nitric acid solution, and holes having a diameter of 1 nm can be formed at 100° C. in 2 hours with hydrogen peroxide.

For removing the tips of the carbon nanohorn 100 that have encapsulated the catalyst and the like, an appropriate temperature range is from 200° C. to 400° C., and an appropriate concentration of an oxygen gas atmosphere is 30 vol % or less. In this case, if the temperature is 200° C. or less, the catalytic action of the encapsulated substances cannot be utilized, so that the carbon layer of the tips cannot be removed. If the temperature is 400° C. or more, the size of the holes of the carbon nanohorn is unfavorably increased by oxidation, causing the catalyst to be separated from the nanohorn. Furthermore, the oxygen concentration of 30 vol % or more is also unfavorable for the same reasons as described above. Moreover, in order to remove the tips of the nanohorn with an oxidation treatment in an acid solution, it is preferable to perform the treatment at a room temperature with a concentration of 30 vol % or less. With a high concentration (more than 30 vol %), the oxidation unfavorably proceeds such as to enlarge the holes of the carbon nanohorn and thus cause the catalyst to be separated from the nanohorn.

Various substances, such as a well-known substance having a function of generating nanotubes, may be used for a substance supported and encapsulated as the encapsulated substance 102 in the carbon nanotubes. Examples of a metal of such a substance include Fe, Ni, Co, Pt, Mo, Al, W, and Mg and alloys containing Fe, Ni, Co, Pt, Mo, Al, W, or Mg as described above. The compound may be in the form of well-known inorganic acid salt or organic acid salt, complex, organic metal compound, or the like. Oxides of the aforementioned metals are preferable for an inorganic substance. Organic functional molecules such as metal-encapsulated fullerene and metal complexes such as ferrocene, phthalocyanine, and cisplatin are preferable for an organic substance. If an atmosphere for introducing those substances is in a vapor phase, a pressure of 1 atmosphere (101325 Pa) or less is preferable. The size and amount of the substance introduced can be controlled by changing the amount of introduction, the temperature, the period of time, and the like. The amount of introduction is preferably up to about 80 weight % with respect to the amount of nanocarbons. The temperature at the time of introduction is preferably in a range of about a room temperature to about 1800° C. The period of time may be up to about 48 hours. In a liquid phase, the size and amount of the substance introduced can be controlled by changing the kind of a solvent, the pH and concentration of a solution, the temperature, the period of time, and the like. At that time, the concentration may be up to a saturation concentration of a solvent. The temperature is preferably in a range of about a room temperature to about 300° C. The period of time may be up to about 200 hours.

Single-layer, double-layer, and triple-layer carbon nanotubes can selectively be produced by using the aforementioned catalyst metal or compound as the encapsulated substance 102 and changing the CVD reaction conditions. Furthermore, the diameter can also be controlled. For example, double-layer carbon nanotubes can primarily be grown by controlling the catalyst size in a range of 3 nm to 10 nm in a case of a single metal of Fe, Ni, or Cr or an alloy of Fe, Ni, or Cr.

In the chemical vapor deposition method (CVD method), carbon nanohorn that support a catalyst metal or a compound thereof can be disposed on a substrate by spraying or the like, or can be used such as to float or transfer in a gas. In the CVD reaction, hydrocarbon compound, as a carbon source compound, such as methane, ethane, ethylene, acetylene, or benzene, alcohol such as methanol or ethanol, CO, and the like are introduced into a reaction system and heated to a temperature ranging from 400° C. to 1200° C. in the presence of argon, as an atmosphere gas, an inert gas such as nitrogen, or a mixed gas of the atmosphere gas, the inert gas, and hydrogen.

Thus, according to the present embodiment, the nanotube-nanohorn complex 1 includes the carbon nanohorn 100, the apertures 101 formed in the carbon nanohorn 100, the catalyst fine particles 102 provided within the apertures 101 in a state in which part of the catalyst fine particles 102 is exposed to the exterior of the carbon nanohorn 100, and carbon nanotubes that have grown from the catalyst fine particles 102.

Accordingly, the nanotube-nanohorn complex 1 has an aspect ratio higher than that of a conventional one and also has high dispersibility. Furthermore, carbon nanotubes can be grown with controlled diameter.

### EXAMPLES

Examples will be shown below, and the present invention will be described in greater detail along with those examples. As a matter of course, the present invention is not limited by the following examples.

### Example 1

Nanotube-nanohorn complexes according to the present invention were manufactured, and field emission characteristics were evaluated.

### Formation of Apertures In Carbon Nanohorns And Metal Encapsulation

Formation of apertures in carbon nanohorn (CNH) was performed by increasing the temperature to 500° C. in dry air by 1° C./min and spontaneously cooling. The resultant product is hereinafter referred to as CNHox. At that time, the flow rate of air was 200 ml/min. After that, metal encapsulation was performed in the following manner: First, iron acetate (50 mg) and CNHox (50 mg) were mixed in an ethanol solution of 20 ml. The mixture was agitated at a room temperature for about 24 hours. Subsequently, the solution was filtered twice by using a filter. Then vacuum drying was conducted for 24 hours. The contained solvents and the like were evaporated and completely removed.

Another sample of catalyst-encapsulated carbon nanohorn that had encapsulated a metal was also produced in a similar manner with use of Co acetate, Gd acetate, Mo acetate, and Co acetate mixture.

### Exposure of Tips of Catalyst In Catalyst-Encapsulated Carbon Nanohorns

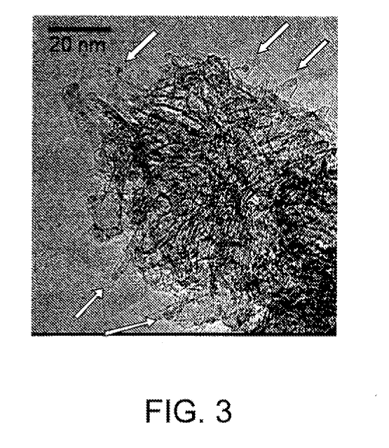

CNHox that had encapsulated iron acetate, which is hereinafter referred to as Fe@CNHox, was heated to 350° C. at a temperature increasing rate of 10° C./min in an electric furnace in which air flowed at 200 ml/min. Then it was left for cooling. FIG. 3 shows electron microscope results at the time. The black portion represents iron fine particles. The upper limit of the size was mostly determined by the size of the sheaths and was in a range of about 1 nm to about 3 nm. Furthermore, as can be seen from arrows of FIG. 3, the catalyst metal was exposed at the tips of the sheaths of the nanohorn.

### Production of Nanotube-Nanohorn Complexes By CVD Method

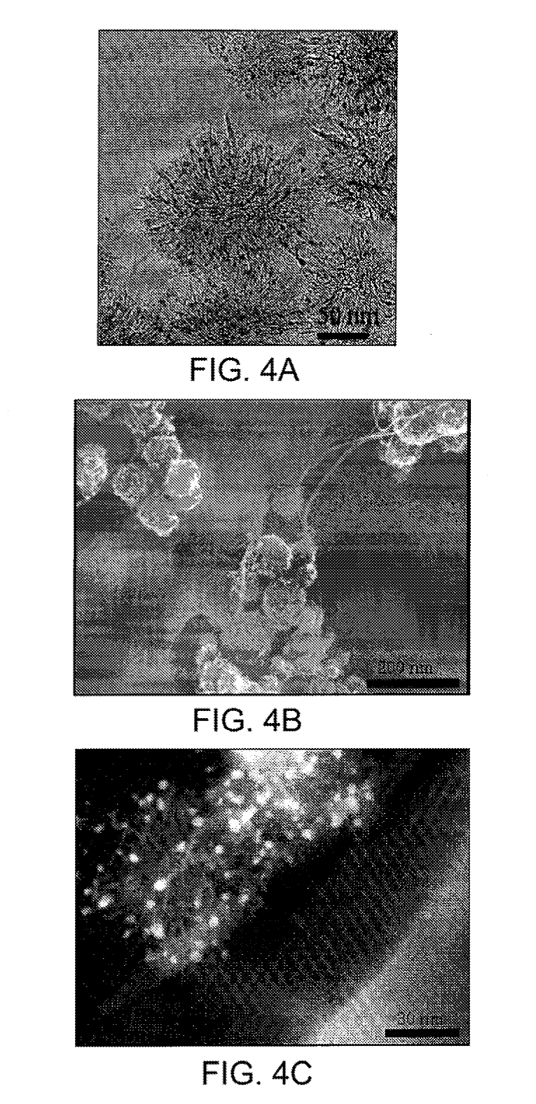

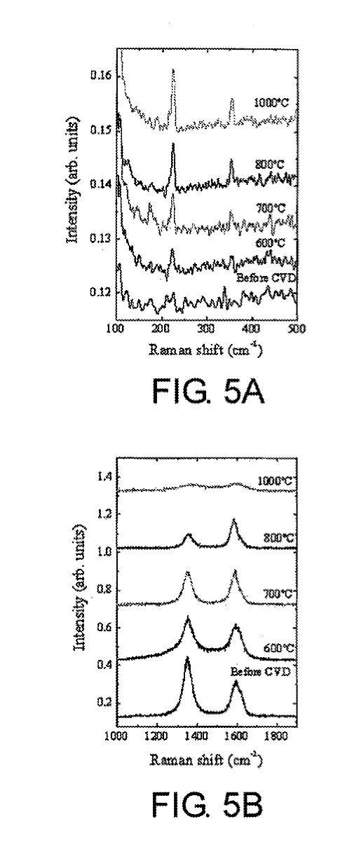

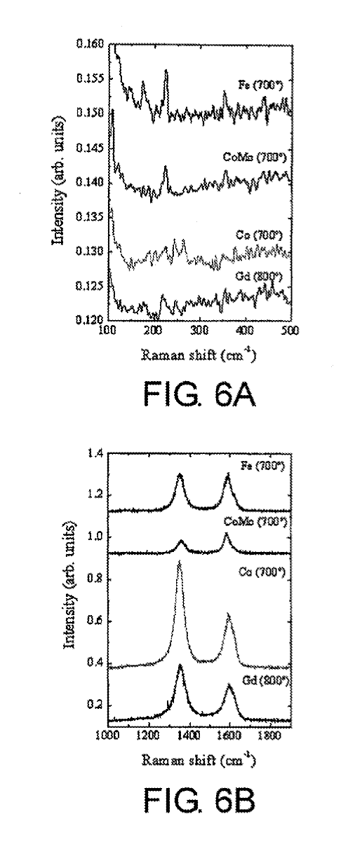

Fe@CNHox produced in the above method was placed in a boat made of alumina, heated to 400° C. in a flow of a mixed gas of argon and hydrogen (500 ml/min of Ar and 50 ml/min of hydrogen), and reduced for 30 minutes. Then it was heated to 700° C. in a flow of argon. Next, an argon gas was bubbled in ethanol, and nanotubes were grown in a mixed gas of argon and ethanol for 20 minutes. FIGS. 4A, 4B, and 4C show electron micrographs of the resultant sample. It is seen from FIGS. 4A, 4B, and 4C that nanotubes had grown from the catalysts on the nanohorn. The generated nanotubes included single-layer nanotubes and double-layer nanotubes. Under the aforementioned conditions, single-layer nanotubes were seen more than double-layer nanotubes. The Raman results of samples obtained by changing the growth temperature are shown (in FIGS. 5A and 5B). As a result, it is seen that the amount of nanotubes increased as the growth temperature was increased and that an amorphous phase was formed at a high temperature. With regard to other catalysts, growth of nanotubes was also attempted by using a CVD method. FIGS. 6A and 6B show the results. Nanotubes grew in the examples of CoMo and Co other than Gd.

### Field Emission Characteristics of Nanotube-Nanohorn Complexes

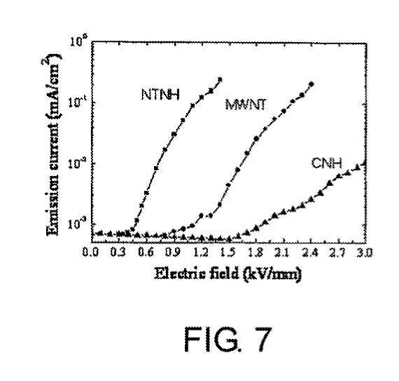

Ultrasonic dispersion was conducted on the resultant samples (200 mg) in α-terpineol (15 ml) for 30 minutes. A cellulose-type organic binder of 200 mg and a glass frit of 400 mg were mixed into the dispersion, and ultrasonic dispersion was conducted for 30 minutes. Paste was screen-printed on a glass substrate on which ITO (Indium-Tin-Oxide) had been sputtered so as to have a thickness of about 100 μm. Then a heat treatment was performed at 500° C. in nitrogen to remove the organic binder. For comparison purposes, pasting and production of an electrode were conducted in the same manner as described above with use of multilayered nanotubes and carbon nanohorn. The current-voltage characteristics of a cathode were measured at a degree of vacuum of 10⁻⁶ Torr (133.322×10⁻⁶ Pa). FIG. 7 shows the measurement results of the field emission characteristics of nanotube-nanohorn complexes (NT/NH), multilayered nanotubes (MWNT), and carbon nanohorn (CNH). It can be seen that a potential at which an electric field is emitted in the nanotube-. nanohorn complexes was lower than those of MWNT and CNH.

It is seen from the above results that a nanotube-nanohorn complex according to the present invention has excellent field emission characteristics as compared to multilayered nanotubes and carbon nanohorn.

The above embodiment and examples have described with regard to the case in which the nanotube-nanohorn complex is used as a material for a field emission element. The present invention is not limited to such a case and is applicable to any structure using a nanotube-nanohorn complex, such as a fuel cell or a catalyst carrier for steam reforming to produce hydrogen from hydrocarbon such as methane.

This application claims the benefit of priority from Japanese patent application No. 2008-169942, filed on Jun. 30, 2008, the disclosure of which is incorporated herein in its entirety by reference.

1. A nanotube-nanohorn complex comprising:
carbon nanohorn; and
catalyst fine particles supported within the carbon nanohorn,
wherein each of the carbon nanohorn comprises an aperture formed therein,
each of the catalyst fine particles is fitted and fixed in the aperture in a state in which part of the catalyst fine particle is exposed to an exterior of the carbon nanohorn, and
carbon nanotubes are grown from the catalyst fine particles.

2. A nanotube-nanohorn complex comprising:
carbon nanohorn and catalyst fine particles supported within the carbon nanohorn,
wherein each of catalyst fine particles is supported at a tip of the carbon nanohorn in a state in which part of the catalyst fine particle is exposed to an exterior of the carbon nanohorn, and
carbon nanotubes are grown from the catalyst fine particles.

3. The nanotube-nanohorn complex as recited in claim 1, wherein the catalyst fine particles comprise Fe, Ni, Co, Pt, Au, Cu, Mo, W, or Mg, a precursor thereof, or an alloy thereof.

4. The nanotube-nanohorn complex as recited in claim 1, wherein the apertures are formed at tips of the carbon nanohorn.

5. The nanotube-nanohorn complex as recited in claim 1, wherein the apertures are formed at side surfaces of the carbon nanohorn.

6. A method of manufacturing a nanotube-nanohorn complex, the method comprising:
(a)forming an aperture in a carbon nanohorn;
(b) introducing a catalyst fine particle or a precursor thereof into the carbon nanohorn through the aperture;
(c) removing the carbon nanohorn around a portion with which the introduced catalyst fine particle or precursor is brought into contact so as to expose part of the catalyst fine particle or the precursor thereof to an exterior of the carbon nanohorn; and
(d) growing a carbon nanotube from the catalyst fine particle or the precursor thereof.

7. The method of manufacturing a nanotube-nanohorn complex as recited in claim 6, wherein the (c) comprises oxidizing and removing the carbon nanohorn around the portion with which the catalyst fine particle or precursor thereof in the carbon nanohorn is brought into contact so as to expose the part of the catalyst fine particle or precursor thereof to the exterior of the carbon nanohorn, and growing the carbon nanotube from a surface of the catalyst.

8. The method of manufacturing a nanotube-nanohorn complex as recited in claim 7, wherein the oxidizing and removing the carbon nanohorn of the (c) is conducted by a heat treatment at a temperature ranging from 200° C. to 400° C. under an atmosphere having an oxygen concentration of 30 vol % or less.

9. The method of manufacturing a nanotube-nanohorn complex as recited in claim 7, wherein the oxidizing and removing the carbon nanohorn of the (c) comprises an oxidation treatment of the carbon nanohorn in an oxidative solution including an oxidant at a concentration of 30 vol % or less and having a temperature ranging from a room temperature to 100° C. to expose the part of the catalyst fine particle or precursor thereof to the exterior of the carbon nanohorn.

10. The method of manufacturing a nanotube-nanohorn complex as recited in claim 6, wherein the (b) comprises introducing Fe, Ni, Co, Pt, Au, Cu, Mo, W, or Mg, as the catalyst fine particle, or a precursor thereof, or an alloy thereof.

11. The method of manufacturing a nanotube-nanohorn complex as recited in claim 6, wherein the (d) comprises growing the carbon nanotube from the catalyst fine particle exposed to the exterior of the carbon nanohorn with use of a carbon source compound under an atmosphere of an inert gas or a mixed gas atmosphere of an inert gas and hydrogen at a temperature ranging from 350° C. to 1000° C. by a chemical vapor deposition method.

12. A field emission element comprising the nanotube-nanohorn complex as recited in claim 1.

13. A fuel cell comprising the nanotube-nanohorn complex as recited in claim 1.

14. A catalyst carrier for steam reforming, comprising the nanotube-nanohorn complex as recited in claim 1.
